(19) United States
(12) Patent Application Publication
(10) Pub. No.: US 2026/0336851 A1
(43) Pub. Date: Oct. 29, 2026

(54) SYSTEM AND METHOD FOR INDIVIDUALLY SEPARATING STACKED CONTAINERS

(71) Applicant: VEMAG Maschinenbau GmbH, Verden (DE)

(72) Inventors: Sebastian Bohling, Verden (DE); Marcel Badenhop, Hellwege (DE)

(21) Appl. No.: 19/655,133

(22) Filed: Apr. 22, 2026

(30) Foreign Application Priority Data
Apr. 23, 2025 (DE) 102025115622.0

(51) Int. Cl. B65B 43/46; B65B 5/06; B65B 65/00

(52) U.S. Cl. CPC B65B 43/46; B65B 5/06; B65B 65/003

(57) ABSTRACT

An unstacking device is provided for individually separating stacked packaging containers. The unstacking device includes a receiving chamber configured to receive a stack of containers so as to be movable in a removal direction, a suction device with at least one suction unit configured to non-positively engage with the respective outer packaging container moved into the removal position by creating a negative pressure, and at least one drive for generating a drive torque. Furthermore, a conveyor device is provided with at least one transport unit which can be positively and/or non-positively engaged with the container stack, and at least one drive for transmitting a drive torque which can be connected to the transport unit.

### CROSS-REFERENCE TO RELATED APPLICATION

This application claims priority to German Patent Application No. 102025115622.0, filed April 23, 2025. The above-mentioned patent application is incorporated herein by reference in its entirety.

### TECHNICAL FIELD

The present invention relates to an unstacking device for individually separating stacked containers. In particular, the invention further relates to a conveyor device for such an unstacking device, and to a method for individually separating stacked containers.

### BACKGROUND

Such unstacking devices are also referred to as “denesters ” and the two terms are used as synonyms in the present disclosure. The term “denester” or “unstacking device” is understood in the present disclosure to mean a device for individually separating empty packaging containers from a stack in a food processing line. The denester is in particular configured to individually remove empty packaging containers, which are positively nested within one another, from a stack and to transfer them in a cycled or continuous manner to a downstream station, in particular a filling station or a sealing station. While other unstacking devices, such as those used in logistics, at airports, or in storage technology, are typically configured to individually separate large-volume, dimensionally stable transport containers, such as large crates, mesh boxes, or luggage trays, the denester described in the present disclosure is specifically designed for individually separating lightweight, thin-walled, and in particular deep-drawn or thermoformed packaging containers, such as those used in the food industry. Such a denester generally comprises mechanical gripping means as a suction unit, particularly in the form of suction cups or vacuum suction devices, for individually separating the packaging containers. Preferably, the suction unit of such a denester can comprise pneumatic means, in particular vacuum means or compressed air means, for releasing individual packaging containers from the stack. For such packaging containers the term “tray” may also be used.

The packaging containers to be individually separated are preferably positively nested within one another. Positive nesting can be understood to mean that a packaging container engages, at least in part, with a packaging container located below, in particular wherein a conical or tapered wall section of an upper packaging container extends into a corresponding wall section of a lower packaging container. The positive nesting can cause adhesive or clamping forces to act between adjacent packaging containers in the stack, which must be overcome during individual separation.

In the field of unstacking devices for packaging lines, it is common to use mechanical systems aimed at separating individual containers of the packaging lines, i.e., packaging containers, from a stack and providing them for further processing steps. Individually separating the packaging containers takes place at cycle rates of 100 or more individual separations per minute.

Known systems typically comprise mechanical retaining devices and pneumatic suction devices, wherein the retaining device retains the container stack above the bottom-most tray, and the suction device engages the bottom-most tray via negative pressure and moves it away from the retained packaging containers. In the event that the two bottom-most trays stick together, which frequently occurs due to plastic deformation caused by the high stack weight, the retaining device retains the stack of containers above the two bottom-most trays that are stuck together, so that they cannot be separated individually but are instead separated together from the rest of the stack.

Other systems comprise a spiral conveyor with separating discs, wherein the separating disc separates the containers from one another and the individually separated container is moved along the spiral conveyor away from the remaining stack of containers towards a removal position. European Patent No. EP 3 912 941 B1, for example, shows such an unstacking device. These systems are often limited to rigid containers with clearly defined edge regions, ensuring that a defined and sufficiently large spacing remains between the containers into which spacing the separating disc can penetrate. However, if the containers stick together due to plastic deformation and their spacing is reduced, the separating disc can no longer penetrate into the spacing between the edge regions of adjacent containers and individually separate them.

Despite considerable progress in the field of unstacking devices, there are still challenges that require further improvement. Existing systems may have difficulties to reliably separate packaging containers, in particular if the containers, as is common with packaging containers, are thin-walled and thus prone to deformation, or when they stick together due to production defects or material variations. This leads to increased susceptibility to errors and can impair the efficiency of packaging lines. Furthermore, many existing systems are not flexible enough to adapt to different container types or production requirements, which limits their applicability in packaging lines and increases the need for specialized solutions.

It would therefore be desirable to at least partially overcome the disadvantages of known systems. More specifically, it would be desirable to provide a device and a method that overcome one or more of the disadvantages of known systems by allowing efficient and reliable separation even of thin-walled packaging containers, while ensuring fast and precise handling.

### SUMMARY

In a first aspect, the present invention provides an unstacking device, or denester, which comprises a conveyor device that includes at least one transport unit. This transport unit can positively and/or non-positively engage with the container stack and is connected to the drive. Such a drive is, in particular, a servomotor. The drive is configured to transmit the drive torque to the conveyor device in order to drive it. The transport unit allows for a guided movement of the container stack in the removal direction, whereby the respective outer packaging container is moved at a defined speed into the removal position so as to be individually separated from the container stack by the suction device. An advantage of the denester according to the invention lies in the precise and controlled movement of the packaging containers into the removal position, which allow for efficient and reliable separation of the stacked containers by the suction unit since the position of the outer container to be separated can be controlled. Thus, a container is always moved towards the removal position and can engage with the suction unit there, with the remaining stack of containers adjacent to the removal position remaining in place via the transport unit. It should be understood that the outer packaging container remains connected to the remaining stack of containers until the release movement is carried out through engagement with the suction unit. As soon as the outer packaging container is individually separated, the transport unit moves the now-outer container to the removal position for separation. This controlled guidance of the respective outer container allows automated separation even with varying container spacing since the position of the outer container is clearly defined and time-controllable. Another advantage is the possibility to convey the container stacks to a removal position independently of the effects of gravity. This can reduce the pressure on the respective outer container and thus minimize the plastic deformation thereof. This helps to prevent the packaging containers from jamming or sticking and increases flexibility in system design.

The denester can include one or more suction units for individually separating the packaging containers from the stack. In the meaning of this disclosure, a suction unit can be understood to mean a unit configured to exert a holding force on a packaging container by negative pressure in order to release it from the stack. The suction unit can comprise one or more suction cups, vacuum suction devices, and/or suction plates connected to a vacuum source, in particular a vacuum pump or a Venturi ejector.

The suction unit can be in particular configured to grip a bottom-most or top-most packaging container of the stack and separate it from the packaging container lying above or below it. Releasing the individual packaging container from the stack preferably takes place against the adhesive and/or clamping forces acting between the nested packaging containers. The suction unit can further contribute to minimize deformation of the packaging container during separation. Since the packaging containers to be individually separated are generally thin-walled and, in particular, deep-drawn or thermoformed, local deformations or damage can occur with mechanical gripping means. Through the application of force over a wide area by negative pressure, gentle separation can be achieved. The suction unit can be advantageous over purely mechanical gripping means, in particular in the case of sensitive or deformable packaging containers.

The suction unit can preferably be actuated in a controlled manner, wherein the negative pressure in particular is activated and deactivated in a cycled or time-controlled manner to release the packaging container in a targeted manner after it has been separated from the stack. Preferably, the suction unit is connected to a control unit of the denester, which controls the separation cycle and/or the negative pressure cycle. Furthermore, the suction unit can cooperate with a sensor for detecting the presence of a packaging container to prevent incorrect separation, in particular the simultaneous removal of two or more packaging containers.

The packaging containers to be individually separated by the denester can include, in particular, trays, bowls, meal trays, cups, lids, sealable trays, or other containers intended for holding food. The packaging containers can be made of plastics, in particular polypropylene, polystyrene, PET, or CPET, cardboard, aluminum, a fiber-molded material, or a composite material. Preferably, the packaging containers have a wall thickness that is typically less than the wall thickness of logistics transport containers, in particular less than 2 mm, preferably less than 1 mm.

Preferably, the conveyor device comprises a plurality of transport units that are arranged spaced apart from one another and each have a contact region configured to positively and/or non-positively engage with the stack of containers. These transport units are designed such that at least one of them can be driven by the drive. It is therefore also possible for the remaining transport units, for example, to merely allow for a guided movement of the stack of containers along their contact region, wherein the driving force is applied to the stack of containers solely by a transport unit connected to the drive. The majority of the transport units allow a smooth and controlled movement of the container stack in the removal direction, thereby increasing the efficiency and accuracy of the unstacking device. The contact region of each transport unit is specially designed to ensure a reliable connection with the container stack, whether through positive fit, in which geometric features of the transport units in the contact region engage with the containers, or through nonpositive fit, in which the connection is achieved through the application of pressure or friction. These mechanisms ensure that the containers are moved safely and stably without slipping or misalignment. The spaced arrangement of the transport units helps to ensure that the stack of containers is evenly supported and the load is optimally distributed.

Preferably, the unstacking device comprises a detection unit configured to detect the respective outer container moved into the removal position, wherein the detection unit preferably comprises an optical sensor. The detection unit plays a central role in the precise control and monitoring of the unstacking process. Due to the integration thereof, for example in the form of an optical sensor, reliable detection of the outer container is achieved as soon as it reaches the removal position. This allows precise synchronization of the subsequent steps, such as activating the suction device and performing the release movement, which causes the outer packaging container, which had previously been guided within the stack of containers, to be released. The optical sensor offers the advantage of high detection accuracy and fast response times, thereby increasing the efficiency and speed of the unstacking process. Additionally, the detection unit can help prevent malfunctions by ensuring that only correctly positioned containers are processed further. Communication between the detection unit and the other components of the unstacking device preferably takes place in real time, ensuring seamless interaction and coordination.

Preferably, the unstacking device comprises a control device that is connected to the detection unit and the drive in a signal-conducting manner. This control device is configured to stop the drive when the detection unit detects an outer container in the removal position. The detection unit serves to detect the outer container in the removal position and to send a signal to the control device. The control device processes this signal and then issues a control command to the drive to stop its movement. This ensures that only the outer packaging container is precisely positioned in the removal position and is ready to be gripped by the suction device. This ensures that the next container is not already being moved into the removal position. This interaction between the detection unit, the control device, and the drive allows precise control over the positioning of the container, which increases the efficiency and reliability of the unstacking process. The detection unit can utilize various technologies, such as optical sensors, infrared sensors, or other suitable detection mechanisms, to detect the outer container. The control device can comprise programmable logic controllers (PLCs) or other control systems capable of processing fast and precise control commands. The advantage of this configuration lies in the improved accuracy and speed of the unstacking process. This reduces the likelihood of misalignment or blockages that could interrupt the unstacking process. Furthermore, the signal-conducting connection between the components allows fast and reliable communication, which is crucial for real-time control of the drive. The combination of these elements helps to improve the overall performance of the unstacking device and increase the efficiency of container processing.

Preferably, the transport unit comprises a drivable transport means that can be positively and/or non-positively engaged with the container stack and extends at least in sections in the direction of removal. The drivable transport means is designed to establish a reliable connection with the container stack, either through positive fit, in which the geometric fit between the transport means and the container stack allows a firm connection, or through nonpositive fit, in which the connection is established by contact pressure or friction. This flexibility in the type of engagement ensures that the device is suitable for different container types and stacking configurations. The transport means runs at least in sections in the direction of removal and thus remains in engagement with the container stack in sections, and, together with the stack, performs a relative movement in the direction of removal along a defined path, that is, a linear movement in certain sections. This guided movement minimizes the risk of misalignment of the containers while continuously ensuring their guidance. Another advantage of the guided movement is the reduction of mechanical stress on the containers since the movement takes place in a smooth and controlled manner. The possibility to drive the transport means also offers the flexibility to adapt the speed and force of the movement to the specific requirements of the unstacking process, leading to further optimization of efficiency.

Preferably, the transport means is designed as a transport belt. This transport belt has an outer engagement surface that is configured to positively and/or negatively engage with the stack of containers. The transport belt allows for precise and controlled movement of the stack of containers in the removal direction, thereby moving the respective outer packaging container into the removal position. The outer engagement surface thus forms the contact region. The outer engagement surface of the transport belt is specially designed to ensure a reliable connection with the stack of containers, which increases the efficiency and accuracy of the unstacking process. The transport belt can be driven by a drive that transmits a drive torque to the transport belt to control the movement of the stack of containers. Another advantage of using a transport belt is the possibility to precisely control the speed and direction of the container stack’s movement, which increases the flexibility and versatility of the unstacking device. The outer engagement surface of the transport belt can consist of a material that provides high adhesion and durability to ensure a reliable connection with the container stack.

Preferably, the outer engagement surface of the transport means is designed to be flat at least in sections and serves to establish a nonpositive connection with the stack of containers. This outer engagement surface allows for improved interaction between the transport unit and the stack of containers by providing a uniform and stable contact surface. The connection can be established regardless of the specific container geometry and, in particular, its edge regions. The flat engagement surface ensures optimal force transmission, making the movement of the container stack into the removal position more precise and controlled. The flat engagement surface helps ensure that the containers are less prone to shifting or slipping during the transport process, which increases the efficiency and reliability of the unstacking device. Another advantage of the flat engagement surface is its ease of manufacture and maintenance, as it does not require complex shapes or structures. This contributes to the cost-efficiency of the unstacking device.

According to an alternative embodiment, the outer engagement surface comprises, at least in sections, a toothed section with teeth extending transverse to the removal direction. This toothing is designed such that a positive engagement with the container stack is possible. The teeth are preferably configured to engage in a gap between two adjacent containers. The toothed section ensures a precise and stable connection between the conveyor device and the stack of containers, which increases the efficiency and reliability of the unstacking process. The positive engagement ensures that the containers are securely held in the removal direction during transport, thereby preventing the containers from slipping or tilting. Furthermore, the arrangement of the teeth transverse to the removal direction allows for optimal force transmission since the teeth engage in the spaces between the containers, thereby creating a direct mechanical connection. This mechanical connection helps ensure that the movement of the container stack in the removal direction can be precisely controlled.

Preferably, the unstacking device comprises a conveyor device that includes at least one drive interface connectable to the at least one drive for transmitting the drive torque of the drive, and at least one deflection unit connected to the drive interface, which is configured to convert the transmitted drive torque of the drive into a movement of the transport means, preferably a linear movement of the transport means, at least in sections, in the removal direction. The drive interface is preferably releasably and positively connectable to the drive for transmitting the drive torque of the drive, and the drive is preferably movable, in particular pivotable, and the drive interface is fixedly received on the unstacking device in such a manner that the drive can be moved from a rest position, in which the drive is spaced apart from the drive interface, into a working position, in which the drive can be brought into engagement with the drive interface. The drive interface serves as a connection point between the drive and the conveyor device, allowing a detachable and positive connection that ensures easy maintenance and interchangeability of the respectively drive in use, and the use of the conveyor device with various drives, respectively. An advantage of this configuration is therefore the increased flexibility and adaptability of the unstacking device since the drive is pivotable and movable and can therefore be easily moved from the rest position to the working position to engage with the drive interface. This allows quick and efficient commissioning of the device.

Preferably, the conveyor device is equipped with a plurality of transport units and is configured to drive them synchronously via the drive interface and the deflection unit by the drive. Using a plurality of transport units increases the stability and reliability of the container stack’s movement since the load is distributed evenly, thereby reducing the risk of jamming or uneven movement. The synchronization of the transport units via the deflection unit and the drive interface allows for precise control of the movement, which improves the efficiency of the unstacking process and shortens cycle times. Moreover, the coordinated movement of the transport units ensures that the outer packaging container always moves precisely into the removal position, which increases the accuracy and repeatability of the unstacking process. Preferably, the removal direction is substantially vertical. Thus, in addition to the transport units, the conveyor device also utilizes gravity to move the containers in the transport direction. This reduces the required drive power and increases the overall efficiency of the unstacking device.

The vertical removal direction also helps reduce mechanical stress on the containers and the device since the movements take place in a natural direction and generate less resistance and friction. This results in a longer service life for the device and lower maintenance requirements. An advantage of the vertical removal direction is the possibility to utilize the ceiling height for installing the unstacking device, which allows efficient use of the available space in often cramped production environments.

Preferably, the conveyor device comprises a catching mechanism. The catching mechanism is configured to engage with at least one packaging container adhering to the outer container in the removal position in order to inhibit the movement thereof in the removal direction. This is particularly advantageous because it allows the outer container to be separated from the adhering container through a targeted release movement without destabilizing the entire stack. The catching mechanism helps to increase the reliability of the unstacking device by preventing multiple containers from reaching the removal position simultaneously or being removed by the suction unit. This facilitates precise and controlled separation of the containers, which increases the efficiency of the entire unstacking process.

Preferably, the unstacking device comprises a catching mechanism which has a catching means with at least one catching edge extending orthogonal to the removal direction. This catching edge protrudes in the direction of a center of the receiving chamber and is designed to engage in an edge region of the containers and to positively engage with at least the outer container. The transport means is designed to completely release the outermost container in the removal position so that it is only held by the catching edge. The outer packaging container deforms elastically as a result of the release movement in order to release the positive fit on the catching edge. This means that the outer container is not released in an uncontrolled manner when released by the transport means, but only through contact with the suction unit and the release movement. Preferably, at least two opposite catching means are provided which have catching edges running parallel to one another and which come into engagement with opposite sides of the containers. In this way, the respective container is held evenly by the catching edges, and tilting is prevented. Preferably, the catching edge is a first catching edge which is designed to positively engage with the outer container and an adhering packaging container. Furthermore, the catching means preferably has a second catching edge, which is designed to positively engage in the edge region of the adhering container upon release of the adhering container from the first catching edge. The catching edges of the catching means engage positively in the edge regions of the containers and thus allow for a precise and controlled separation of the containers from one another. The elastic deformation of the packaging containers during the release movement helps to release the positive fit and separate the containers from each other without damaging the containers.

Preferably, the unstacking device comprises a guide mechanism which surrounds the receiving chamber and is configured to releasably receive at least the transport units at a plurality of mounting positions distributed orthogonal to the removal direction. This means that the transport units can be mounted flexibly and at different positions along the guide mechanism, allowing precise and controlled movement of the stack of containers in the removal direction. The guide mechanism ensures that the transport units are at a defined spacing from the removal position in the removal direction in each of the mounting positions, which ensures that the containers are guided evenly and reliably even when the positioning of the transport units changes. This flexibility in the mounting position of the transport units allows adaptation to different container sizes and shapes, which increases the versatility of the unstacking device.

Alternatively or additionally, the guide mechanism is preferably configured to releasably receive the catching mechanism at a plurality of mounting positions orthogonal to the removal direction. This allows flexible positioning of the catching mechanism which is used to securely grip and transport the outer container after separation from the stack. The guide mechanism ensures that the catching mechanism can be mounted in different mounting positions and can therefore be adapted to different container sizes.

The possibility to position both the transport units and the catching mechanism at different mounting positions along the guide mechanism makes the unstacking device extremely flexible and adaptable to different container types and sizes.

Preferably, the guide mechanism extends at least in sections along a longitudinal extent orthogonal to the removal direction and, in operation, parallel to an outer edge of the containers, and is configured to continuously receive the transport unit and/or the catching mechanism along the longitudinal extent. The guide mechanism preferably has a guide body which runs along the longitudinal extent and which is configured to continuously receive the transport unit and/or the catching mechanism along the longitudinal extent. This configuration allows precise and flexible guidance of the transport unit and/or the catching mechanism, ensuring optimal positioning and movement of containers of different sizes. The stepless receiving along the longitudinal extent offers the advantage of fine adjustment of the position of the transport unit and/or the catching mechanism, resulting in improved handling. The guide body is preferably designed as a guide rod or a guide tube.

Preferably, the catching mechanism comprises a locking device which is configured to non-positively engage with the guide body to lock the catching mechanism. In particular, the locking device comprises a retaining part for at least nonpositive coupling with the guide body and a clamping element for applying a clamping force to the retaining part. The nonpositive coupling of the retaining part to the guide body creates a secure connection that prevents unintentional movement of the catching mechanism. The clamping element allows this nonpositive coupling by applying the clamping force. The precise locking of the catching mechanism by the locking device minimizes the risk of malfunctions or damage to the stacked containers and thus contributes to the longevity and robustness of the unstacking device. Due to the nonpositive connection, the catching mechanism can be engaged with the guide body in a stepless manner at any position, which ensures adaptation to different container sizes.

Preferably, the transport unit comprises a guide receptacle, which can be engaged with the guide body in each case in such a manner that the transport unit is locked in the removal direction and can be moved along the longitudinal extent. The guide receptacle guides the transport unit securely and stably along the longitudinal extent of the guide body and additionally stabilizes the positioning thereof. Alternatively or additionally, the catching mechanism preferably comprises a guide recess which can be engaged with the guide body in each case in such a manner that the catching mechanism is locked in the removal direction and can be moved along the longitudinal extent. The guide recess guides the catching mechanism securely and stably along the longitudinal extent of the guide body and additionally stabilizes the positioning thereof. Together with the fixation by the locking mechanism, the guide recess ensures a rotationally fixed locking of the catching mechanism.

It is preferred that the drive interface is configured to receive the drive torque and to provide it to the deflection unit as input torque about an input axis, wherein the deflection unit has a gear which is configured to translate the input torque into an output torque about at least one main drive axis and to provide it to the at least one transport unit, wherein the input torque and the output torque differ in amount, or the input axis is different from the main drive axis. The gear in the deflection unit plays a decisive role in converting the input torque into an output torque that differs in terms of amount - i.e., in terms of the magnitude of the acting torque - or in terms of its direction of action - i.e., in terms of the direction of the torque about the axis or the direction of the axis around which the torque acts. This means that the torque can be varied as required and the existing installation space and also necessary torques or restrictions can be taken into account.

Preferably, the gear has a deflection mechanism with a drive shaft which is driven via a drive means, in particular a drive chain, driven by the drive interface by the input torque about an input axis running parallel to the removal direction, and at least one output shaft, which is at an angle, in particular orthogonal, to the drive shaft, and is connected to the drive shaft at least indirectly in a torque-transmitting manner, such that the at least one transport unit is driven by the output shaft with the output torque v_{OUT}. By using a drive chain as the drive means, a robust and reliable connection is created that ensures uniform power transmission. This translation of the torque into a torque about another axis, in particular an orthogonal axis, is particularly advantageous as it allows easy transmission to multiple transport units distributed along these main drive axes which, positioned next to each other, can move the stack of containers together. This means that multiple transport units can be driven in parallel with just one drive. The parallel alignment of the drive shaft to the removal direction ensures efficient use of space, while the orthogonal arrangement of the output shaft allows optimum power transmission and motion control to multiple transport units which are in engagement with the output shaft.

Preferably, the gear further comprises a distribution mechanism with an auxiliary output shaft which is driven directly by the input shaft, the auxiliary output shaft being in torque-transmitting engagement with two output shafts in order to connect the output shafts indirectly to the input shaft. This means that multiple output shafts can be indirectly connected to the drive shaft via the auxiliary output shaft and thus operated with just one drive. This also allows that two or more drive shafts, and thus the transport units driven by them, are driven in parallel. Further preferably, the auxiliary output shaft preferably has a worm wheel that engages with a toothing of the drive shaft in a torque-transmitting manner. The use of a worm wheel allows a compact design of the gear, which means that the unstacking device can be used in a space-saving and flexible manner in various environments. Furthermore, the tendency of the worm wheel towards self-locking provides additional safety for the unstacking device. In the event of a sudden drive failure, self-locking occurs between the worm wheel and the toothing on the drive shaft in engagement therewith so that the transport units come to a standstill and the stack of containers cannot simply slide, for example due to gravity.

The gear preferably comprises at least two spaced-apart bevel gear units associated with the distribution mechanism, the bevel gear units each having a drive bevel gear wheel arranged on the auxiliary output shaft and an output bevel gear wheel which is arranged on the respective output shaft and which is in engagement with the drive bevel gear wheel and is driven with the output torque about the main drive axis. The bevel gear allows a compact design and flexible adaptation of the direction of movement. The drive bevel gear wheels, which are mounted parallel and spaced apart from each other on the auxiliary output shaft, ensure uniform power transmission to the output shafts connected to the output bevel gear wheels and thus to multiple transport units by engaging with a corresponding number of output bevel gears. The precise and efficient transmission of power through the bevel gear helps the unstacking device to reliably and quickly separate stacked containers, which significantly increases productivity and efficiency in applications where fast and reliable separation of containers is required.

Preferably, the output shaft is positively connected to at least one of the transport units to transmit the output torque. This connection allows an efficient transmission of the torque from the output shaft to the transport units, whereby the stack of containers can be moved in the desired removal direction. A preferred embodiment of such a positive connection is a non-circular cross-section, in particular a polygonal cross-section, of the output shaft which offers the advantage of improved torque transmission and prevents the shaft from slipping in the shaft receptacle of the transport units. The corresponding shaft receptacle of the transport units is preferably specially designed for this non-circular cross-section, which optimizes the mechanical connection between the output shaft and the transport units and allows precise control of the movements of the container stack. This mechanical connection helps to increase the efficiency of the unstacking device by ensuring reliable and stable movement of the containers. The catching mechanism, which preferably has a rotatably mounted and corresponding bearing point, is also designed for the non-circular cross-section. This bearing point allows the catching mechanism to be securely locked in the removal direction, which increases the stability and safety of the unstacking device. Due to the positive connection between the output shaft and the transport units as well as the corresponding bearing point of the catching mechanism, precise and controlled movement of the containers is ensured, which improves the efficiency of the unstacking device and reduces the risk of malfunctions.

Preferably, the receiving chamber is formed at least in sections by the conveyor device, such that the transport units are in contact with the stack of containers at at least three spaced-apart contact points in order to define the stack’s positioning relative to the direction of removal and to prevent torsion of the stack of containers. This means that the conveyor device is not only responsible for transporting the stack of containers but also plays a structural role by partially forming the receiving chamber. The three contact points provide stable and precise positioning of the stack of containers, which is particularly important for ensuring uniform and reliable removal of the containers. This arrangement prevents torsion of the container stack, thereby maintaining the integrity and alignment of the containers during the unstacking process. This is advantageous because torsion could lead to faulty removal, which would impair the entire process. Furthermore, a guide plate which is configured to guide the stack of containers toward the receiving chamber is preferably associated with the receiving chamber. The guide plate serves as a guiding aid that positions the stack of containers correctly and ensures that the containers are moved properly into the removal position. This contributes to the efficiency and accuracy of the unstacking process by minimizing potential misalignments and blockages of the stack of containers. The combination of these features results in improved functionality of the unstacking device by ensuring precise and reliable positioning and movement of the containers. The interaction between the conveyor device and the receiving chamber, as well as the support provided by the guide plate, provide an optimized solution for separating stacked containers by improving the mechanical stability and guidance of the container stack.

Preferably, the guide mechanism comprises a connecting rod that extends orthogonal to the longitudinal direction. This connecting rod can be engaged with the guide body running along the longitudinal axis at multiple positions, wherein this engagement can in particular be achieved in a stepless manner. This configuration creates a variable projection area of the receiving chamber which is defined by the guide body and the connecting rod. This projection area can be adapted to the containers, allowing flexible handling of different container sizes and shapes. The stepless adaptability of the connecting rod to the guide body allows for quick and easy conversion to different container types, which increases the flexibility of the device in various industrial applications.

In a second aspect, the present invention provides a conveyor device that is designed for use in an unstacking device, in particular an unstacking device according to the first aspect of the invention. The conveyor device comprises one or more transport units that can be positively and/or non-positively engaged with a stack of containers. These transport units are configured such that they can be connected to at least one drive of the unstacking device to drive the transport unit. The transport unit is configured to move a stack of containers received in a receiving chamber of the unstacking device in a predetermined removal direction, thereby moving a respective outer container of the stack of containers into a removal position. The present invention according to the second aspect incorporates the advantages described at the beginning with regard to the first aspect of the present invention through the specific configuration of the conveyor device. Advantages and preferred embodiments of the unstacking device according to the first aspect of the present invention are likewise advantages and preferred embodiments of the conveyor device according to the second aspect of the present invention.

In a third aspect of the present invention, a packaging line is provided for packaging products in containers, in particular food products, which comprises at least one unstacking device according to the first aspect of the invention. This unstacking device is capable of receiving stacked containers and moving them individually to a removal position where they are separated by a suction device. This suction device uses negative pressure to non-positively grip the outer container and separate it from the stack via a release movement. The packaging line also comprises at least one feeding belt that feeds the products into a packaging region and transfers them to the separated containers. The feeding belt is configured to transport the products continuously and uniformly, ensuring a consistent speed and precision when transferring the products to the containers. Furthermore, the packaging line includes at least one feeding device that transports the separated containers to the packaging region. This feeding device ensures that the containers reach the packaging region in an orderly and controlled manner, which facilitates the integration of the various components of the packaging line and ensures smooth operation. Finally, the packaging line comprises at least one packaging unit that packages the products in the individually separated containers within the packaging region. This packaging unit is designed to package the products efficiently and securely into the containers, wherein various packaging methods and techniques can be applied to meet the specific requirements of the products. Overall, by utilizing an unstacking device according to the first aspect of the invention, the packaging line incorporates the advantages described at the beginning with regard to the first aspect of the invention. The advantages and preferred embodiments of the unstacking device according to the first aspect of the present invention are likewise advantages and preferred embodiments of the packaging line according to the third aspect of the present invention.

In a fourth aspect of the present invention, a method is provided for individually separating stacked containers comprises multiple steps aimed at moving a stack of containers in a defined removal direction and removing the containers individually. First, the stack of containers is received in such a manner that the outermost container in the removal direction can be moved into a removal position. A transport unit is positively and/or non-positively engaged with the stack of containers and is driven by a drive that generates a drive torque. The stack of containers is guided and moved by the transport unit in the removal direction so that the outermost packaging container is moved into the removal position. Negative pressure is generated by a suction unit to non-positively engage with the respective outermost container in the removal position. Subsequently, a release movement is carried out by the suction unit, which separates the outer container from the stack of containers. The method incorporates the advantages described initially with respect to the first aspect of the present invention through the targeted guidance of the stack of containers by the transport unit. The advantages and preferred embodiments of the unstacking device according to the first aspect of the present invention are also advantages and preferred embodiments of the method according to the fourth aspect of the present invention.

### BRIEF DESCRIPTION OF THE DRAWINGS

The invention is described below with reference to preferred exemplary embodiments and the accompanying figures.

FIG. 1 is a perspective view of an embodiment of an unstacking device comprising a receiving chamber, multiple transport units, and a guide mechanism.

FIG. 2 is a plan view of the embodiment of an unstacking device of FIG. 1 with the guide mechanism surrounding the receiving chamber.

FIG. 3 is an elevation view of the embodiment of an unstacking device of FIG. 1 with a receiving chamber, a conveyor device, and a catching mechanism.

FIG. 4 is a further elevation view of the embodiment of the unstacking device of FIG. 1 with multiple transport units and a catching mechanism.

FIG. 5 is a further elevation view of the embodiment of a unstacking device of FIG. 1 with a conveyor device, a receiving chamber, and a catching mechanism.

FIG. 6a is a first perspective view of an embodiment of a transport unit.

FIG. 6b is a second perspective view of the embodiment of a transport unit of FIG. 6a.

FIG. 6c is a detailed view showing toothing of the transport unit of FIG. 6a.

FIG. 7 is a top perspective schematic representation of a gear system configured to convert an input torque into an orthogonal output torque.

FIG. 8 is a bottom perspective view of an embodiment of a gear with multiple bevel gears and drive shafts.

FIG. 9 is a perspective view of an embodiment of a catching mechanism of the unstacking device.

FIG. 10 is a schematic illustration of a packaging line with an unstacking device for individually separating stacked containers according to embodiments of the present invention.

FIG. 11 is a perspective view of an embodiment of an unstacking device for individually separating stacked containers.

FIG. 12 is a schematic flowchart of a method for individually separating stacked containers according to embodiments of the present invention.

### DETAILED DESCRIPTION

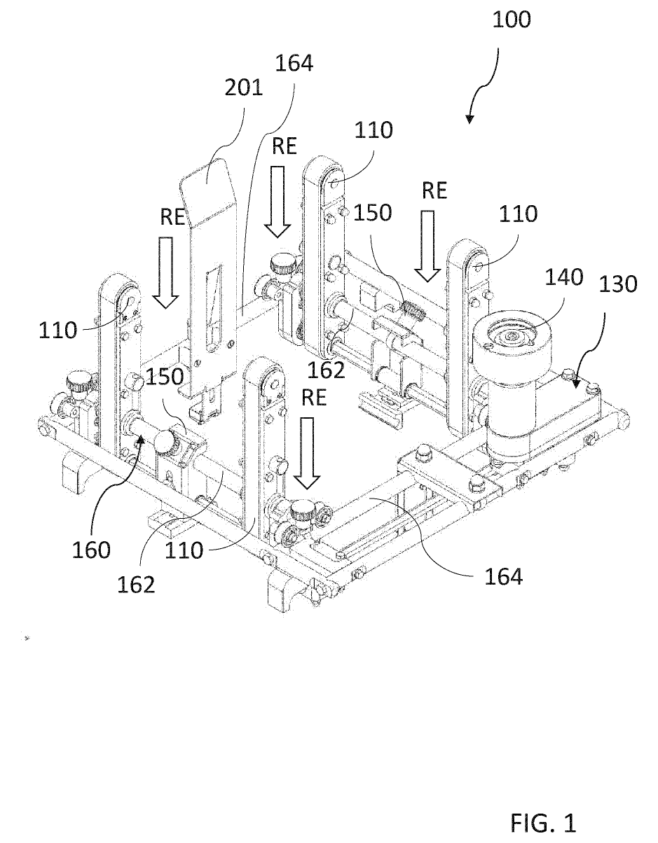

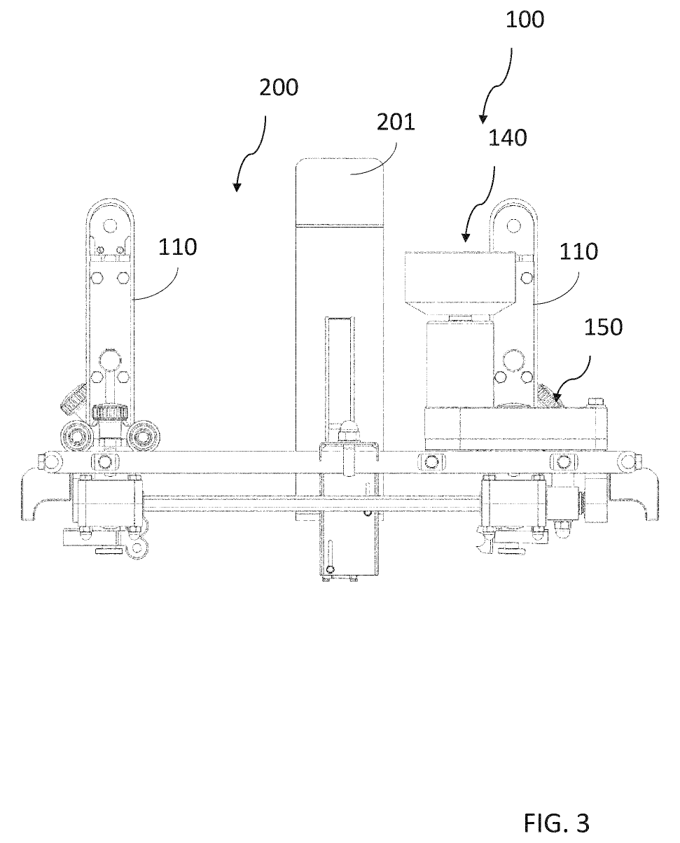

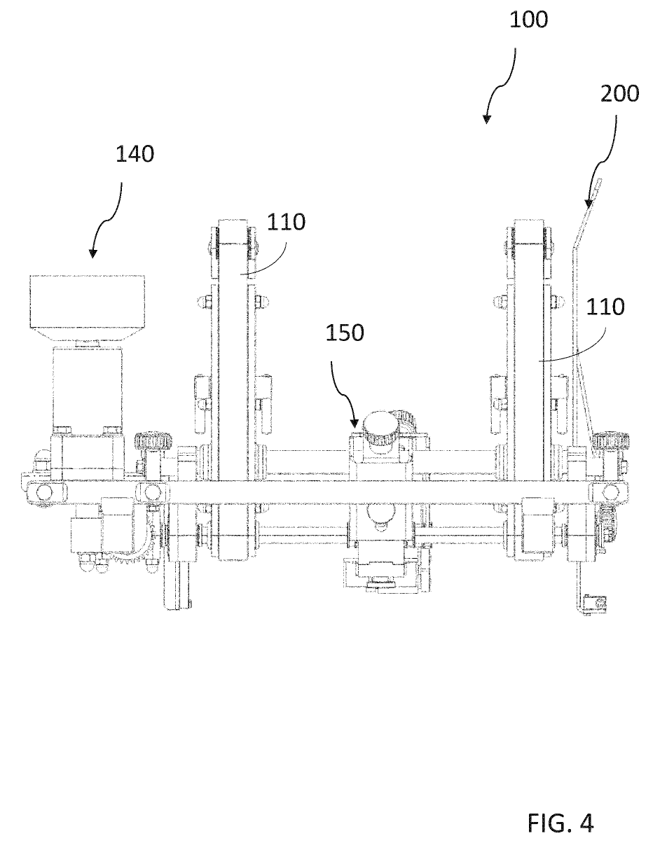

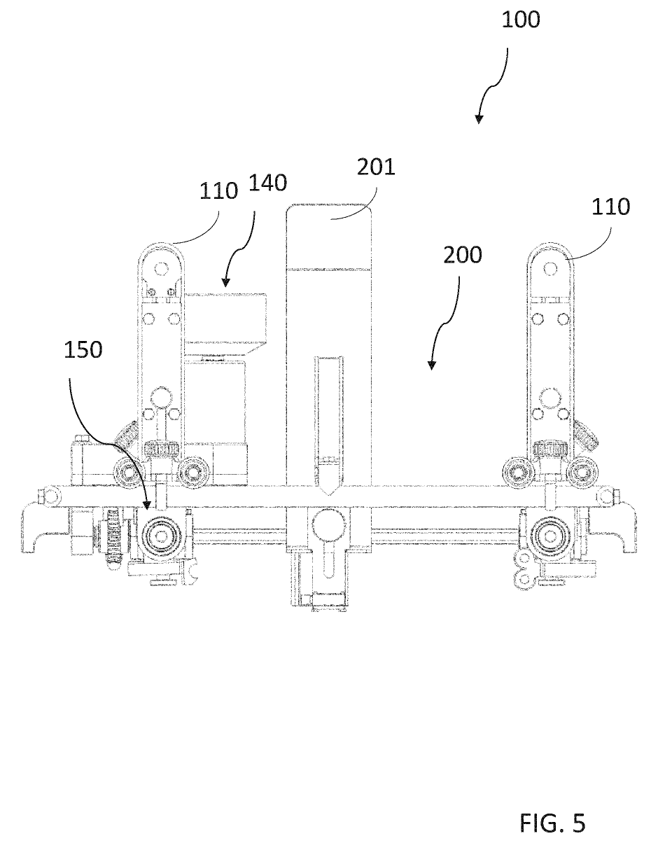

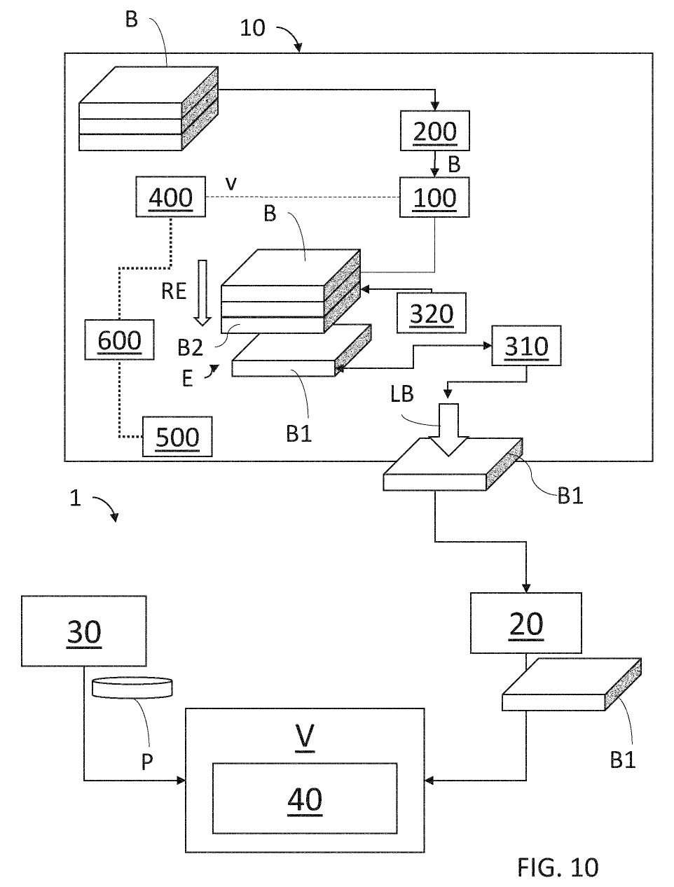

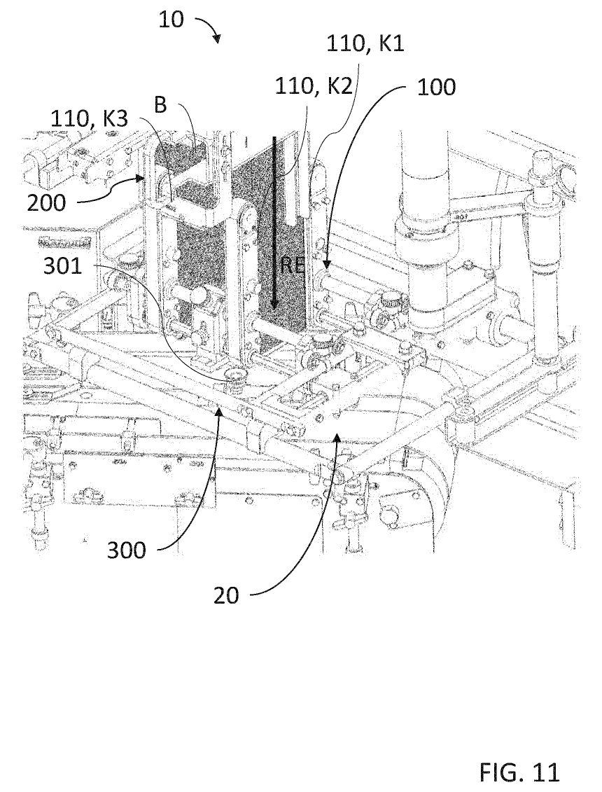

FIGS. 1 through 5 illustrate an unstacking device 10 for individually separating stacked containers B1, B2 (cf. FIG. 10). The unstacking device 10 comprises a conveyor device 100 with multiple transport units 110, which are configured to move a stack of containers B (cf. FIG. 11) in a removal direction RE (cf. FIG. 1), and a receiving chamber 200 in which the stack of containers B is received.

The receiving chamber 200 is designed to receive the stack of containers B such that it can move in the removal direction RE, wherein in each case one outer packaging container B1 is moved into the removal position E. The receiving chamber 200 is preferably formed at least in sections by the conveyor device 100. A guide plate 201 is associated with the receiving chamber 200 and serves to guide the container stack B toward the receiving chamber 200 when it is introduced into the unstacking device 10.

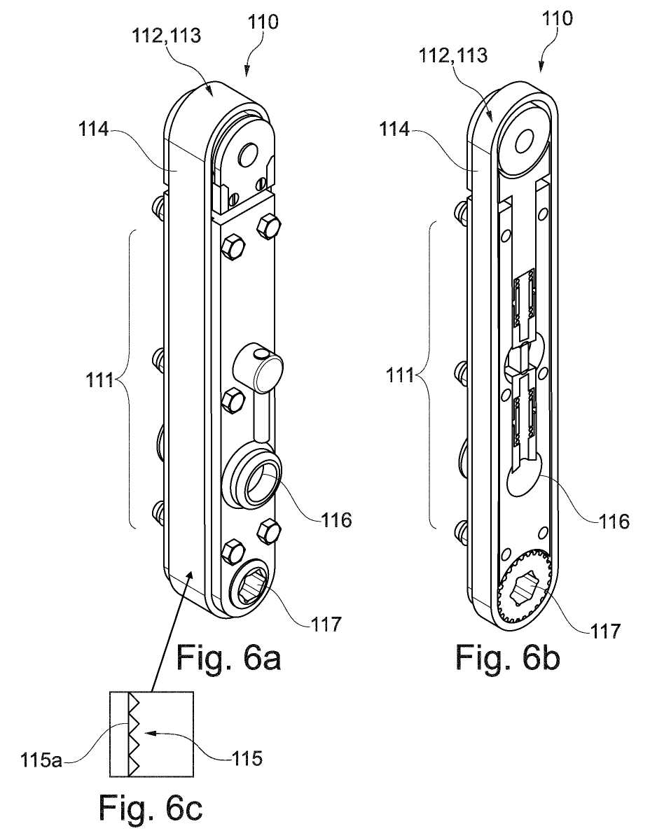

The transport units 110 can be positively and/or non-positively engaged with the container stack B. For this purpose, the transport units 110 are preferably equipped with a transport means 112 (cf. FIG. 6a through FIG. 6c), and their mode of operation is described in detail in connection with FIG. 6a through FIG. 6c.

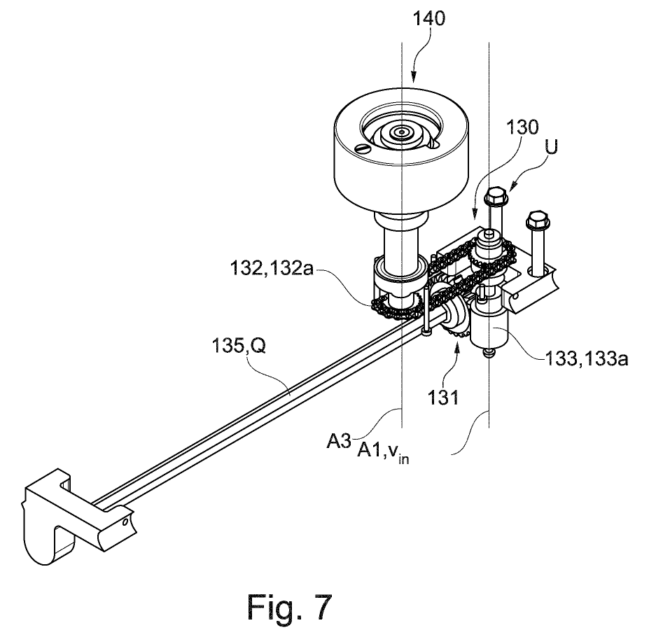

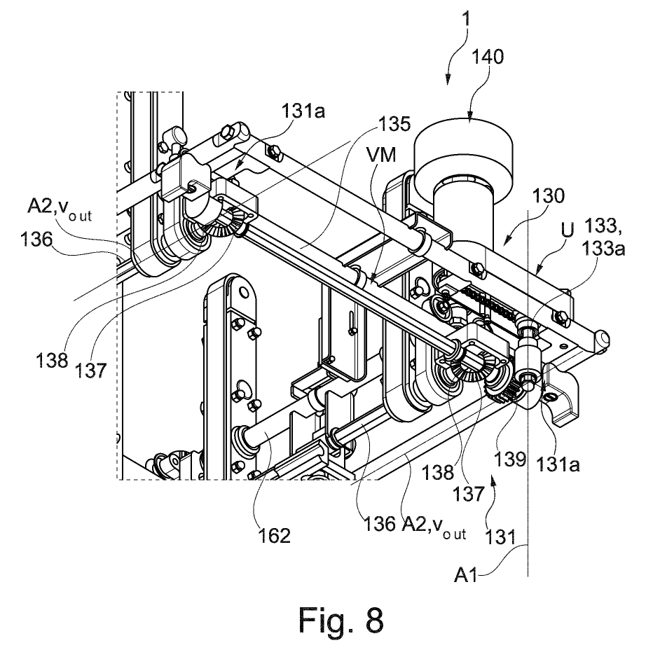

The unstacking device 10 comprises a drive 400 (cf. FIG. 10), which generates a drive torque v and is connected to the transport unit 110 via a drive interface 140. The drive interface 140 is configured to transmit the drive torque v of the drive 400. The drive interface 140 can preferably be releasably and non-positively connected to the drive 400. The drive 400 is movable, in particular pivotable, and the drive interface 140 is fixedly mounted on the unstacking device 10. The drive 400 can be moved from a rest position, in which it is spaced apart from the drive interface 140, into a working position, in which it can be engaged with the drive interface 140. The drive interface 140 transmits the drive torque v to the transport units 110, wherein a deflection unit 130 converts the drive torque into a movement of the transport means 112. The drive interface 140 is configured to receive the drive torque v and to provide it to the deflection unit 130 as an input torque v_{In} acting about an input axis A1 (cf. FIG. 10). The exact structure and mode of operation of the deflection unit 130 are described in detail in connection with FIG. 7 and FIG. 8.

The plurality of transport units 110 can preferably be driven synchronously via the drive interface 140 and the deflection unit 130 by the at least one drive 400.

Furthermore, the conveyor device 100 is equipped with a catching mechanism 150, which is configured to engage with a packaging container B2 adhering to the outer packaging container B1 in the removal position E in order to inhibit its movement in the removal direction RE. The exact structure and mode of operation of the catching mechanism 150 are described in detail in connection with FIG. 7 and FIG. 8.

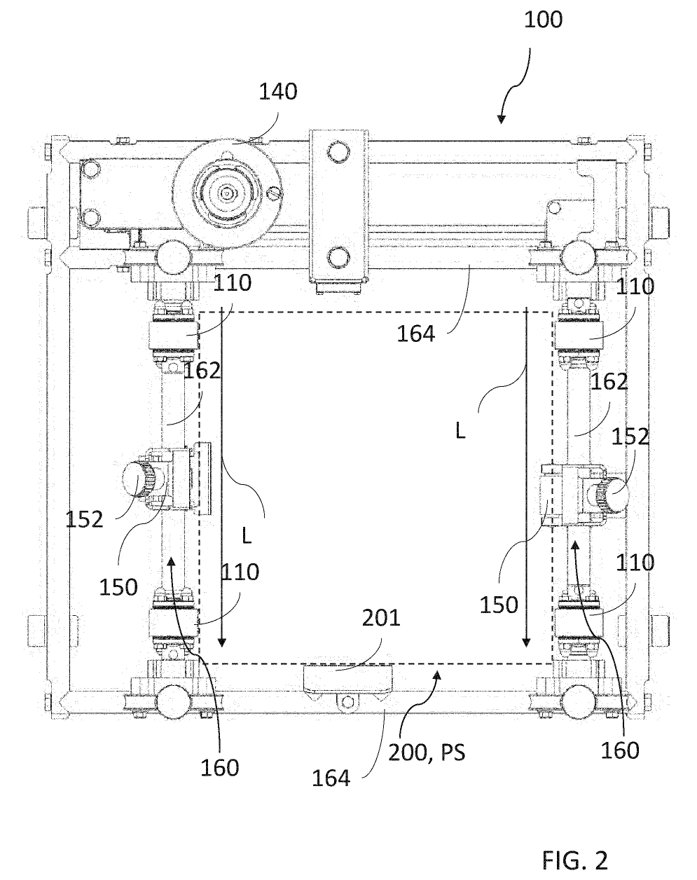

The conveyor device 100 comprises a guide mechanism 160 that surrounds the receiving chamber 200 and releasably receives the transport units 110 at multiple mounting positions orthogonal to the removal direction RE. The guide mechanism 160 extends along a longitudinal dimension L (cf. FIG. 2) and is preferably configured to receive the transport units 110 in a stepless manner. The guide body 162 extends along the longitudinal dimension L and serves to receive the transport units 110 in a stepless manner.

In the present case, the guide mechanism 160 comprises two connecting rods 164 that can be engaged with two guide bodies 162 extending along the longitudinal dimension L at a plurality of positions such that the receiving chamber 200 has a variable projection area P (cf. FIG. 2) which is defined by the guide body 162 and the connecting rod 164 and which can be adapted to the containers B. Two of the transport units 110 are connected in each case to one of the two guide bodies 162 which extends along the longitudinal axis L and preferably receives the transport units 110 in a stepless manner.

FIGS. 6a and 6b show perspective front and rear views of a transport unit 110 that is part of the conveyor device 100, as used in the unstacking device 10 according to FIGS. 1 through 5.

The transport unit 110 comprises a contact region 111 that is configured to positively and/or non-positively engage with the container stack B.

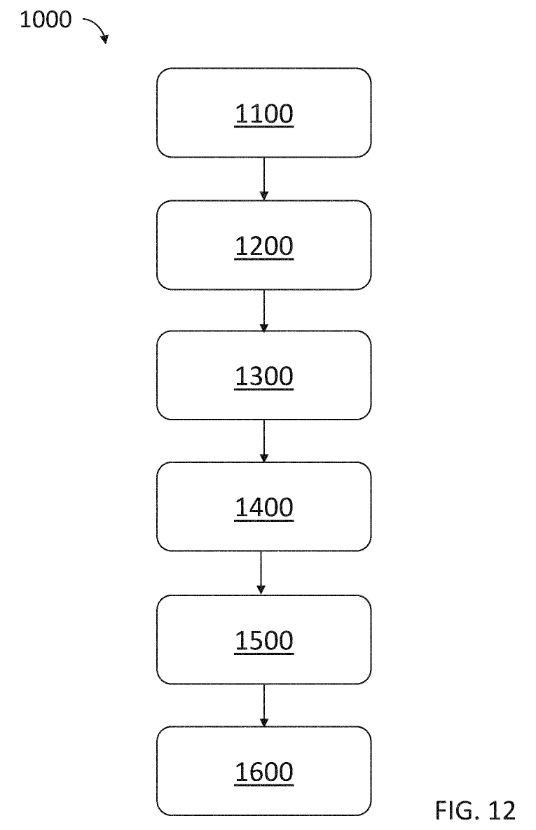

The transport unit 110 further comprises a transport means 112, which is designed as a transport belt 113. The transport belt 113 has an outer engagement surface 114 which is configured to positively and/or non-positively engage with a container stack B (cf. FIG. 12). The outer engagement surface 114 thereby forms the contact region 111 which is configured to positively and/or non-positively engage with the container stack B.

In FIG. 6a and 6c, the outer engagement surface 114 is formed to be substantially planar at least in sections and is configured for nonpositive engagement with the container stack B.

In addition, FIG. 6c shows an alternative configuration of the engagement surface 114 in which the engagement surface comprises a toothed section 115 having teeth 115a extending transverse to the removal direction RE. These teeth 115a are configured to positively engage in a spacing between two adjacent containers B1, B2 (cf. FIG. 10). This ensures safe and stable transport of the containers by the transport unit 110.

Furthermore, a guide receptacle 116 is illustrated which can be engaged with the guide body 162 (cf. FIG. 1). The guide receptacle 116 is designed to allow for variable and adjustable positioning of the transport unit 110 along the guide body 162 and to lock it in a defined position relative to the removal position E.

The transport unit 110 also has a shaft receptacle 117 which is formed to correspond to a non-circular cross-section. This shaft receptacle 117 allows a positive connection with an output shaft (cf. FIG. 8) which serves to drive the transport unit 110.

The design of the transport unit 110 is intended to allow reliable and efficient movement of the container stack while simultaneously optimizing positioning and engagement with the container stack. The combination of transport belts 113, contact region 111, guide receptacle 116, and shaft receptacle 117 ensures that the transport unit 110 meets the requirements for precise and controlled movement within the unstacking device.

The design of the transport unit is intended to allow reliable and stable movement of the container stack, with the engagement surface 114 playing a central role. It is designed to provide an optimal contact surface for securely holding and moving the container stack. The guide receptacle 116 and the shaft receptacle 117 are integral components of the transport unit that ensure its functionality and efficiency in operation.

FIG. 7 shows a detailed illustration of the connection between the drive interface 140 and the deflection unit 130. The drive interface 140 is configured to absorb the drive torque v from the drive 400 (cf. FIG. 10) and to provide it to the deflection unit 130 as an input torque v_{IN} acting about an input axis A1. The drive interface 140 itself is driven by the drive 400 about a third axis A3 running parallel to the first axis A1.

The deflection unit 130 comprises a gear 131, which converts the input torque v_{IN} acting about the input axis A1 into an output torque v_{OUT} that acts about at least one main drive axis A2 (cf. FIG. 8) running orthogonal to the first axis A1. One or more transport units 110, in this case two transport units 110, are driven in each case about this main drive axis A2.

The input torque v_{In} can differ from the output torque v_{Out}. Furthermore, the input axis A1 differs from the main drive axis A2 such that the input torque v_{In} and the output torque v_{Out} differ with respect to their axes of action so that the utilized torque can be flexibly deflected and adapted to the spatial conditions of the unstacking device 10.

The gear 131 comprises a deflection mechanism U with a drive shaft 133 which is driven by the input torque vᵢₙ via a drive means 132 driven by the drive interface 140 about an input axis A1 running parallel to the removal direction RE. The drive means 132 used can preferably be a drive chain 132a that engages both a distal shaft end associated with the drive interface 140 and the drive shaft 133 and transmits torque between them.

Furthermore, the gear 131 comprises two output shafts 136 which in this case are orthogonal to the drive shaft 133 and are indirectly connected to the drive shaft 133 in a torque transmitting manner. Alternative embodiments in which only one output shaft 136 is provided to drive the transport units are also possible. The two output shafts 136 are arranged parallel to and spaced apart from one another and are each in engagement with two of the transport units 110 in order to transmit the output torque v_{Out} to them and drive them.

In the embodiment shown, the gear 131 further comprises a distribution mechanism VM with an auxiliary output shaft 135. The auxiliary output shaft 135 is driven directly by the drive shaft 133 and serves to drive the two output shafts 136 in parallel with one another. For this purpose, the auxiliary output shaft 135 is in torque-transmitting engagement with the output shafts 136 and thus indirectly connects them to the drive shaft 133.

The auxiliary output shaft 135 preferably has a worm wheel that has toothing 133a that engages with the drive shaft 133 in a torque-transmitting manner.

Furthermore, the distribution mechanism VM of the gear 131 comprises at least two bevel gear units 131a arranged spaced apart from one another. Each of the bevel gear units 131a comprises a drive bevel gear wheel 137 arranged on the auxiliary output shaft 135, and an output bevel gear wheel 138 which is arranged on the respective output shaft 136 and which engages with the drive bevel gear wheel 137 and is driven by the output torque v_{Out} about the main drive axis A2.

As shown in FIG. 8, the output shaft 136 is positively connected to at least one, preferably at least two, of the transport units 110 for transmitting the output torque v_{Out}. This connection is achieved by positive engagement in that the output shaft 136 has a polygonal cross-section. The transport units 110 have a corresponding shaft receptacle 117 (cf. FIG. 6a and FIG. 6b) that matches the present polygonal cross-section Q to ensure a secure and efficient transmission of the output torque v_{OUT}. Other non-circular cross-sections are also possible.

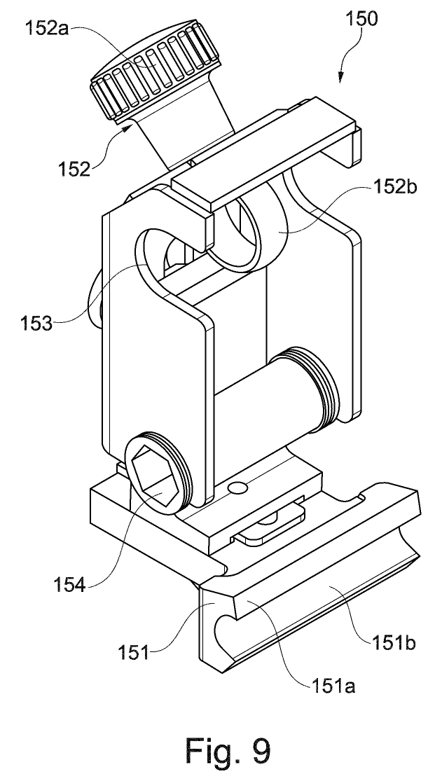

FIG. 9 shows a detailed illustration of the catching mechanism 150 which is part of the unstacking device 10. The catching mechanism 150 is configured to engage with at least one packaging container B2 adhering to the outer packaging container B1 in the removal position E (cf. FIG. 10) in order to inhibit the movement thereof in the removal direction RE. This allows the outer packaging container B1 to be separated from the adhering container B2 by the release movement in the removal direction RE (cf. FIG. 11).

In the present case, the catching mechanism 150 is configured to also engage with the outer packaging container B1 in the removal position E (cf. FIG. 10), wherein the transport units 110 are configured to release the outer packaging container B1 in the removal position E so that the latter is preferably held solely by the catching mechanism 150.

The catching mechanism 150 comprises a catching means 151 which in the present case has two catching edges 151a and 151b extending orthogonal to the removal direction RE (cf. FIG. 1). These catching edges 151a, 151b are configured to project towards a center of the receiving chamber 200 and are configured to engage an edge region of the containers.

The catching means 151 comprises a first catching edge 151a which is configured to positively engage with the outer packaging container B1 and the adhering container. Furthermore, the catching means 151 has a second catching edge 151b which is configured to positively engage with the edge region of the attached container B2 when the attached container B2 is released together with the outer packaging container B1 from the first catching edge 151a. Thus, the outer packaging container B1 is released from the first catching edge 151a due to its elastic deformation resulting from the release movement and also slides past the second catching edge 151b. However, the adherent container B2 is not non-positively coupled to the suction unit and experiences the force applied by the suction unit to the outer packaging container B1 to perform the release movement only indirectly via the outer container. This force is insufficient to effect elastic deformation of the adhering container B2 to overcome the catching means 151, so that the adhering container B2 is retained at the first and second catching edge, respectively, and is detached from the outer packaging container B1.

The catching mechanism 150 is equipped with a locking device 152 which is configured to non-positively engage with the guide body 162 (cf. FIG. 1) to lock the catching mechanism 150 in place. The locking device 152 comprises a retaining part 152b for at least partially nonpositive coupling with the guide body 162, and a clamping element 152a for applying a clamping force to the retaining part 152b. This design allows precise positioning and fixation of the catching mechanism 150 along the provided guide.

In additional, the catching mechanism 150 is provided with a guide recess 153 that can be engaged with the guide body 162 in such a manner that the catching mechanism 150 is additionally locked in the removal direction RE and is movable along the longitudinal extent L (cf. FIG. 2). This allows for flexible adaptation of the position of the catching mechanism 150 to handle different container sizes or shapes.

In addition, the catching mechanism 150 comprises a bearing point 154 for mounting the output shaft 136. The bearing point 154 of the catching mechanism 150 is rotatably mounted and formed to correspond to the non-circular cross-section Q (cf. FIG. 7). This bearing point 154 is configured to additionally lock the catching mechanism 150 in the removal direction E and to stabilize the output shaft 136, which ensures stable and reliable operation of the unstacking device.

FIG. 10 schematically shows an unstacking device 10 for individually separating stacked containers B1, which is integrated into a packaging line 1. The process flow for packaging products using the packaging line is illustrated schematically.

In addition to the unstacking device 10, the packaging line 1 comprises at least one feeding belt 30 which is configured to feed products P into a packaging region V and to transfer the products P to the individually separated packaging containers B1. A feeding device 20 is configured to feed the individually separated outer packaging containers B1 to the packaging region V, and a packaging unit 40 is configured to package the products P in the individually separated containers B1 in the packaging region V.

The unstacking device 10 of packaging line 1 comprises, as described with reference to FIG. 1 through FIG. 5, a conveyor device 100 and a receiving chamber 200 configured to receive a stack of containers B in a removal direction RE so that in each case one packaging container B1 located on the outside in the removal direction RE can be moved to a removal position E.

The conveyor device 100 is equipped with at least one transport unit 110 which is driven by a drive 400 that generates a drive torque v and transmits it to the transport unit 110 to move the stack of containers B in the removal direction RE.

A suction device 300 with at least one suction unit 310 is configured to positively engage with the respective outer packaging container B1 moved into the removal position E by creating a negative pressure and to carry out a release movement LB in the removal direction RE so that the outer packaging container B1 is separated from the container stack B in the removal position E by the release movement LB.

The unstacking device 10 further has a detection unit 500 which preferably comprises an optical sensor 501, and is configured to detect the respective outer container B1 moved into the removal position E. The detection unit 500 is connected in a signal-conducting manner to a control device 600 of the unstacking device 10, which is configured to stop the drive 400 upon detection of an outer container B1 in the removal position E by the detection unit 500.

FIG. 11 shows a detailed view of the unstacking device 10 for individually separating stacked containers of a container stack B. The unstacking device 10 is designed analogously to the embodiment shown in FIG. 1 through FIG. 5, and reference is made to the description thereof.

The conveyor device 100 is equipped with at least four transport units 110 of which only three are visible here. These three transport units 110 shown are each in contact with the container stack B at one of the three contact points K1, K2, and K3 in order to stabilize the container stack B and fix the position thereof relative to the removal direction RE, as well as to prevent torsion of the container stack B. Thus, they form a receptacle for the container stack B.

In the illustrated exemplary embodiment, the suction device 300 comprises a suction unit 301 which is arranged below the conveyor device 100 in the removal direction. The suction unit 301 is configured to non-positively engage with the respective outer packaging container B1 moved into the removal position E by creating a negative pressure and to carry out a release movement LB (cf. FIG. 10) in the removal direction RE. This release movement LB separates the outer packaging container B1 from the container stack B at the removal position E.

In the present embodiment, the conveyor device 100 is configured such that the removal direction RE runs vertically. The suction unit 301 is strategically positioned below to efficiently grip and release the outer packaging container B1, with gravity acting as an assist during the conveyance of the outer container B1 to the removal position E and during the release of the container by the suction unit 301.

In addition, the feeding device 20 of the packaging line 1 is shown in FIG. 10, which is configured to feed the individually separated packaging containers B1 to the packaging region (cf. FIG. 10). The feeding device 20 is positioned such that it conveys the packaging containers B1 after they have been individually separated by the unstacking device 10. FIG. 12 illustrates a flowchart of method 1000 for individually separating stacked containers. The following description of method 1000 is provided with reference to the description of the unstacking device 10 in connection with FIG. 1 through FIG. 11.

The first step 1100 of method 1000 comprises receiving a container stack B such that the container stack B is movable in a defined removal direction RE. This ensures that an outer packaging container B1 can be moved into a specific removal position E.

In the second step 1200, at least one transport unit is positively and/or non-positively engaged with the stack of containers. This transport unit plays a key role in the controlled movement of the stack of containers and ensures that the outer packaging container is moved into the removal position.

The third step 1300 describes the driving of the transport unit by a drive unit designed to generate a driving torque. The drive unit is crucial for the mechanical movement of the transport unit and thus for the continuation of the process.

The fourth step 1400 comprises the guided movement of the container stack B in the removal direction by the transport unit. This step ensures that the outer packaging container is moved into the removal position to make it available for the next process step.

In the fifth step 1500, a negative pressure is created by a suction unit 301. This suction unit 301 is configured to non-positively engage with the outer packaging container B1 which has been moved to the removal position E. The negative pressure generated allows the outer packaging container B1 to be securely gripped and held in place for the subsequent steps.

The final step 1600 comprises carrying out a release movement in the removal direction. This movement is carried out by the suction unit that is engaged with the outer container. The purpose of this release movement is to separate the outer container from the stack of containers at the removal position so that it is ready for further processing steps.

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. An unstacking device for separating stacked packaging containers, comprising:
a receiving chamber configured to receive a container stack so as to be movable in a removal direction which extends substantially in vertical direction, such that in each case one packaging container located on the outer side in the removal direction can be moved into a removal position,
a suction device with at least one suction unit configured to non-positively engage with the respective outer packaging container moved into the removal position by creating a negative pressure, and to carry out a release movement in the removal direction in such a manner that the outer packaging container is separated from the container stack in the removal position by the release movement,
at least one drive for generating a drive torque, and
a conveyor device with a transport unit that can be positively and/or non-positively engaged with the container stack, and at least one drive for transmitting a drive torque that can be connected to the transport unit,
wherein the transport unit is configured to move the container stack in a guided manner in the removal direction, wherein the respective outer packaging container is moved into the removal position in order to be separated from the container stack by the suction device.

2. The unstacking device according to claim 1, wherein the conveyor device is equipped with a plurality of transport units, at least one of which can be driven by the drive, and which are arranged spaced apart from one another and each have a contact region configured to positively and/or non-positively engage with the container stack.

3. The unstacking device according to claim 1, further comprising:
a detection unit configured to detect the respective outer packaging container moved into the removal position, wherein the detection unit comprises an optical sensor, and
a control device connected to the detection unit and the drive in a signal-conducting manner, which is configured to stop the drive when an outer packaging container is detected in the removal position by the detection unit.

4. The unstacking device according to claim 2, wherein the transport unit comprises in each case one drivable transport means that can be positively and/or non-positively engaged with the container stack and extends at least in sections in the removal direction, and wherein the transport means is a transport belt which has an outer engagement surface for positively and/or non-positively engaging with the container stack, and which forms the contact region.

5. The unstacking device according to claim 4, wherein the outer engagement surface is designed to be substantially planar at least in sections, and is designed for non-positively engaging with the container stack.

6. The unstacking device according to claim 5, wherein the outer engagement surface has, at least in sections, a toothed section with teeth extending transverse to the removal direction, which is designed for positively engaging with the container stack, wherein the teeth are each configured to engage in a spacing between two adjacent packaging containers.

7. The unstacking device according to claim 6,
wherein the conveyor device has a drive interface connectable to the at least one drive for transmitting the drive torque of the drive, and at least one deflection unit connected to the drive interface, which is configured to deflect the transmitted drive torque of the drive into a linear movement of the transport means, at least in sections, of the transport means, in the removal direction,
wherein the drive interface for transmitting the drive torque of the drive is releasably and positively connectable to the drive, and wherein the drive is pivotable, and the drive interface is fixedly received on the unstacking device such that the drive can be moved from a rest position, in which the drive is spaced apart from the drive interface, into a working position in which the drive can be engaged with the drive interface, and
wherein the conveyor device is equipped with a plurality of transport units and is configured to drive the plurality of transport units synchronously via the drive interface and the deflection unit by the at least one drive.

8. The unstacking device according to claim 1, wherein the conveyor device has a catching mechanism configured to engage with a container adhering to the outer packaging container in the removal position in order to inhibit a movement thereof in the removal direction, such that the outer packaging container is separated from an adhering packaging container by the release movement in the removal direction,
wherein the catching mechanism comprises a catching means having a catching edge extending orthogonal to the removal direction, which protrudes towards a center of the receiving chamber and is designed to engage in an edge region of the packaging containers and to positively engage at least with the outer packaging container, wherein the outer packaging container is elastically deformed as a result of the release movement for releasing a positive fit acting on the catching edge,
wherein the catching edge is a first catching edge configured to positively engage with the outer packaging container and the adhering container, and
wherein the catching means further comprises a second catching edge configured to positively engage in the edge region of the adhering container upon release of the adhering container from the first catching edge.

9. An unstacking device according to claim 8,
wherein the conveyor device has a guide mechanism that surrounds the receiving chamber,
wherein the guide mechanism is configured to releasably receive at least the transport unit at a plurality of mounting positions orthogonal to the removal direction, wherein the transport unit has a defined spacing from the removal position in the removal direction in each of the mounting positions, and
wherein the guide mechanism is configured to releasably receive the catching mechanism at a plurality of mounting positions orthogonal to the removal direction, wherein the guide mechanism has a defined spacing from the removal position in the removal direction in each of the mounting positions.

10. The unstacking device according to claim 9,
wherein the guide mechanism extends at least in sections along a longitudinal extent orthogonal to the removal direction and, in operation, parallel to an outer edge of the packaging containers, and is configured to receive at least one of the transport unit and the catching mechanism along the longitudinal extent in a stepless manner,
wherein the guide mechanism has a guide body which extends along the longitudinal extent and which is configured to receive at least one of the transport unit and the catching mechanism along the longitudinal extent in a stepless manner.

11. The unstacking device according to claim 10,
wherein the catching mechanism has a locking device which is configured to non-positively engage with the guide body to lock the catching mechanism,
wherein the locking device comprises a retaining part for at least also non-positively coupling with the guide body, and a clamping element for applying a clamping force to the retaining part.

12. The unstacking device according to claim 10,
wherein the transport unit has a guide receptacle and the catching mechanism has a guide recess, each of which can be engaged with the guide body in such a manner that the transport unit and the catching mechanism are locked in the removal direction and are movable along the longitudinal extent.

13. The unstacking device according to claim 7,
wherein the drive interface is configured to absorb the drive torque and provide it to the deflection unit as an input torque about an input axis, wherein the deflection unit comprises a gear configured to transform the input torque to an output torque about at least one main drive axis and to provide it to the at least one transport unit, wherein the input torque and the output torque differ in magnitude, or the input axis is different from the main drive axis.

14. The unstacking device according to claim 13,
wherein the gear has a deflection mechanism with a drive shaft that is driven via a drive means defined by a drive chain, driven by the input torque about an input axis running parallel to the removal direction, and at least one output shaft that is at an orthogonal angle to the drive shaft, and is connected to the drive shaft at least indirectly in a torque-transmitting manner such that the transport unit is driven by the output shaft with the output torque,
wherein the gear further comprises a distribution mechanism with an auxiliary output shaft that is driven directly by the drive shaft, wherein the auxiliary output shaft is in torque-transmitting engagement with two output shafts to indirectly connect the output shafts to the drive shaft, and
wherein the auxiliary output shaft has a worm wheel that is in torque-transmitting engagement with a toothing of the drive shaft.

15. The unstacking device according to claim 14, wherein the gear comprises at least two spaced-apart bevel gear units which are associated with the distribution mechanism, wherein the bevel gear units each have a drive bevel gear wheel arranged on the auxiliary output shaft and an output bevel gear wheel which is arranged on the respective output shaft and which is engaged with the drive bevel gear wheel and is driven about the main drive axis with the output torque.

16. The unstacking device according to claim 14,
wherein the output shaft for transmitting the output torque is positively connected to at least one of the transport units; the output shaft has a polygonal cross-section, and the transport units have a shaft receptacle formed to correspond to the non-circular cross-section, and
wherein the catching mechanism has a rotatably mounted bearing point which is formed to correspond to the non-circular cross-section and which can be brought into engagement to lock the catching mechanism in the removal direction.

17. The unstacking device according to claim 1,
wherein the receiving chamber is formed at least in sections by the conveyor device such that the transport units are in contact with the container stack along at least three spaced-apart contact points in order to define the stack’s positioning relative to the removal direction and to prevent torsion of the container stack,
wherein a guide plate, which is configured to guide the container stack in the direction of the receiving chamber, is associated with the receiving chamber.

18. The unstacking device according to claim 10, wherein the guide mechanism has a connecting rod which extends orthogonal to the longitudinal extent and which, at a plurality of positions, can be engaged in a stepless manner, with at least one of the guide bodies running along the longitudinal extent, such that the receiving chamber has a variable projection surface which is defined by the guide body and the connecting rod and which can be adapted to the containers.

19. A packaging line for packaging products in packaging containers, comprising:
at least one of the unstacking devices according to claim 1, which is configured for individually separating stacked packaging containers, and which includes at least one transport unit which can be positively and/or non-positively engaged with the container stack, and which can be connected to at least one drive of the unstacking device for driving the transport unit, wherein the transport unit is configured for moving a container stack received in a receiving chamber in a guided manner in a removal direction and for releasing a respective outer packaging container of the container stack in the removal position,
at least one feeding belt configured to feed products into a packaging region and for transferring the products to the individually separated packaging containers,
at least one feeding device configured to feed the individually separated packaging containers to the packaging region, and
at least one packaging unit configured to package the products in the individually separated packaging containers in the packaging region.

20. A method for individually separating stacked packaging containers, comprising:
receiving a stack of containers so as to be movable in a removal direction in such a manner that in each case one packaging container located on the outside in the removal direction can be moved into a removal position,
positively and/or non-positively engaging a transport unit with the stack of containers,
driving the transport unit by a drive which is designed to generate a drive torque,
moving the stack of containers in a guided manner in the removal direction by the transport unit, wherein the outer packaging container is moved into the removal position,
producing a negative pressure by a suction unit for nonpositive engagement with the respective outer packaging container moved into the removal position, and
carrying out a release movement in the removal direction by the suction unit engaged with the outer packaging container such that the outer packaging container is separated from the stack of containers in the removal position by the release movement.
